(19) United States
(12) Patent Application Publication
(10) Pub. No.: US 2021/0209621 A1
(43) Pub. Date: Jul. 8, 2021

(54) SYSTEMS AND METHODS FOR DETERMINING PROFITABILITY SCORE OF AN INCOMING CUSTOMER CALL

(71) Applicant: Calvin Lim, Edmonton (CA)

(72) Inventor: Calvin Lim, Edmonton (CA)

(21) Appl. No.: 17/139,199

(22) Filed: Dec. 31, 2020

Related U.S. Application Data
(60) Provisional application No. 62/956,333, filed on Jan. 2, 2020.

(51) Int. Cl. G06Q 30/02; G06N 20/00

(52) U.S. Cl. CPC G06Q 30/0201; G06N 20/00

(57) ABSTRACT

Methods, systems, and apparatus including computer programs encoded on a computer-readable storage medium and a method for determining certain characteristics of an incoming customer's profile and for providing smart recommendations to a business regarding the customer in real time are disclosed. The system discusses a system where telephone devices are connected to a computing system with CRM database. The computing system manages the communication systems such as telephone and uses the same to identify details of an incoming caller or further allows to update or add new customer's information. The system furthermore presents a graphical user interface presenting the analytical details of the incoming caller along the score generated by machine learning techniques to present up to mark customer support services.

### FIELD OF INVENTION

The present invention relates to techniques for providing customer data analytics for providing enhanced profitability. More particularly, the present invention is related to techniques for determining a customer's profitability score in real time upon receiving an incoming call from a potential customer.

### BACKGROUND OF THE INVENTION

Providing satisfactory customer support is an integral part of every business. It has been established time and again by many businesses that providing the best customer support is the fundamental strategy to keep up with competition. Hence, businesses are focusing more on providing high quality customer support to keep their customers happy and content.

Conventional methods for providing customer support include providing solutions to issues faced by customers by communicating with them via voice (phone based support) or text (e-mail and live chat). In most cases, customer support executives are employed to directly communicate with customers and provide them a reasonable solution to the issues faced by them. While experienced personnel may handle even the toughest customers with relative ease, it may not be possible to employ such personnel for handling every request. Furthermore, customers may come from different backgrounds which makes the task even more difficult.

As more and more business transact over telephone call, it has become absolutely important for a business to manage incoming calls and prioritize them based on company requirements such as clients profitability and risk. The use of machine learning system could assist in calculating exposure of each client, and display as business intelligent on the phone to help businesses to make better decisions. It will be advantageous to provide an intelligent system and method that uses customer data to determine a score for each customer in real-time when a business receives incoming calls from said customers. A technical solution that provides real time insights to increase quality of service will be advantageous for both customers and businesses.

### SUMMARY OF THE INVENTION

The present disclosure discusses a system and a method for determining certain characteristics of an incoming customer's profile and provide smart recommendations to a business regarding the customer in real time. Embodiments disclosed herein discloses an arrangement wherein a system managing telephone devices is tightly coupled to a computing system with CRM database. The computing system manages the communication systems such as telephone and uses the same to identify details of an incoming caller. The system displays the details of the incoming caller along with a score generated by machine learning techniques to determining and show how important the caller is to the business.

### BRIEF DESCRIPTION OF THE DRAWINGS

FIG. 1 is an illustrative representation 100 of the architecture for facilitating the embodiments described by the present invention.

FIG. 2 is an illustrative representation 200 of a telephonic device displaying the end result of the present invention.

### DETAILED DESCRIPTION

One arrangement for the present disclosure, is computing system of provider institution that tightly integrate telephone devices and computing system with CRM database, and its accessibility to a phone incoming caller's phone number (herewith referred as Caller ID) that identify who the (actual) caller is and display on the phone, along with a score generated by machine learning system showing how important the caller is to the company.

One arrangement of the present disclosure is a method. Showing the correct customer name on the phone is important, as most caller ID passed from phone company does not represent the actual customer as the phone number's registered owner, in some cases, no information of caller's name is passed on to the receiving party, but only the incoming telephone number. To achieve this identification process, customers phone number is previously recorded to the company's CRM database. When a call comes with caller ID, system picks up the caller ID and search the CRM database for matching number. If found, it will take the score generated from the machine learning module and replace the original caller ID with the relevant score obtained through machine learning and customer's name recorded on CRM earlier and passed on as changed caller ID to the phone display screen.

In some arrangements, the provider institution can collect and store transactional information of the incoming call in the course of the phone conversation back to CRM database, associated with the caller identified. The electronic transaction may be processed by the provider computing system to help calculate the score on machine learning. (E.g. called time, duration, purpose of call)

If caller number is not found on CRM, the CRM will give a screen to allow phone operator to key in the name of the (new) client, or have additional phone number to a customer's CRM record. Once this is in the database, the subsequent call will result in showing the name and does not necessarily imply that each such reference is to the same embodiment(s) or that the score on the phone screen display.

One arrangement of the present disclosure is a method. Showing the correct customer name on the phone is important, as most caller ID passed from phone company does not represent the actual customer as the phone number's registered owner, in some cases, no information of caller's name is passed on to the receiving party, but only the incoming telephone number. To achieve this identification process, customer's phone number is previously recorded to the company's CRM database. When a call comes with caller ID, system picks up the caller ID and search the CRM database for matching number. If found, it will take the score generated from the machine learning module and replace the original caller ID with the relevant score obtained through machine learning and customer's name recorded on CRM earlier and passed on as changed caller ID to the phone display screen.

In some arrangements, the provider institution can collect and store transactional information of the incoming call in the course of the phone conversation back to CRM database, associated with the caller identified. The electronic transaction may be processed by the provider computing system to help calculate the score on machine learning. (E.g. called time, duration, purpose of call)

In the following description of the embodiments of the invention, reference is made to the accompanying drawings that form a part hereof, and in which are shown by way of illustration specific embodiments in which the invention may be practiced. These embodiments are described in sufficient detail to enable those skilled in the art to practice the invention, and it is to be understood that other embodiments may be utilized and that changes may be made without departing from the scope of the present invention.

The specification may refer to “an”, “one” or “some” embodiment(s) in several locations. feature only applies to a single embodiment. Single feature of different embodiments may also be combined to provide other embodiments.

As used herein, the singular forms “a”, “an” and “the” are intended to include the plural forms as well unless expressly stated otherwise. It will be further understood that the terms “includes”, “comprises”, “including” and/or “comprising” when used in this specification, specify the presence of stated features, integers, steps, operations, elements and/or components, but do not preclude the presence or addition of one or more other features integers, steps, operations, elements, components, and/or groups thereof. As used herein, the term “and/or” includes any and all combinations and arrangements of one or more of the associated listed items.

Unless otherwise defined, all terms (including technical and scientific terms) used herein have the same meaning as commonly understood by one of ordinary skill in the art to which this disclosure pertains. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

In an embodiment of the present disclosure, a computing system of provider institution that is tightly integrated to telephone devices and computing system with CRM database is provided. The system has capabilities for determining incoming caller's phone number (herewith referred as Caller ID) that may identify who the (actual) caller is and displays the same on the phone. Further the system displays a score generated by a machine learning system showing how important the caller is to the company.

One arrangement of the present disclosure is a method. Showing the correct customer name on the phone is important, as most caller ID passed from phone company does not represent the actual customer as the phone number's registered owner, in some cases, no information of caller's name is passed on to the receiving party, but only the incoming telephone number. To achieve this identification process, customer's phone number is previously recorded to the company's CRM database. When a call comes with caller ID, system picks up the caller ID and searches the CRM database for matching numbers. If found, it will take the score generated from the machine learning module and replace the original caller ID with the relevant score obtained through machine learning and customer's name recorded on CRM earlier and passed on as changed caller ID to the phone display screen.

In some arrangements, the provider institution can collect and store transactional information of the incoming call in the course of the phone conversation back to CRM database, associated with the caller identified. The electronic transaction may be processed by the provider computing system to help calculate the score on machine learning. (E.g. called time, duration, purpose of call).

If caller number is not found on CRM, the CRM will give a screen to allow phone operator to key in the name of the (new) client, or have additional phone number to a customer's CRM record. Once this is in the database, the subsequent call will result in showing the name and score on the phone screen display.

Herein, the computing system includes one or more processor and one or more computer-readable storage media communicatively connected to one or more processors, and having instructions stored thereon that known as IP PBX (Internet Protocol Private Branch eXchange). The instructions upon execution, cause one or more processors to receive electronic signal thereon known as VoIP (Voice Over Internet Protocol) containing electronic signal which identifying originator's telephone number to initiate an electronic transaction to another instructions on the same or another computing system known as CRM (Customer Relationship Management System), which the instruction of the system is to identify the account associated with the caller ID by comparing the phone number stored on the computer-readable storage media communicatively connected.

Once identified, the system will then pass the electronic signal to the IP PBX system identifying the account associated with name and a score, which is generated by instruction on a computing system which calculate a profitability score for the electronic transaction based on the caller profile, transmit a notification to the answering phone device replacing any incoming caller ID with the information corresponding to the caller stored in a data store, recalculate the score based on the comparison, and transmit an electronic signal to the user device to cause the display of a result of the recalculation and the name of the account.

The devices (mainly VOIP Phone) connected to the system will ring and display both score and name on its display, while the CRM will have a record inserted to database, along with the voice recording on the phone conversation

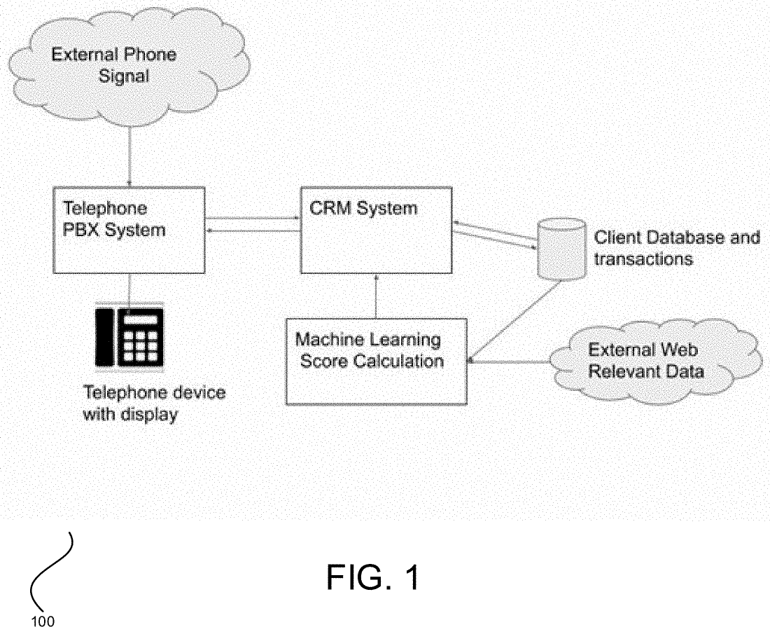

FIG. 1 is an illustrative representation 100 of the architecture for facilitating the embodiments described by the present invention. Herein, the telephone PBX system is communicatively connected to external communication means, telephonic devices, and a CRM system. The CRM system is further connected to a client database which is further connected to external web. The CRM systems receives determined customer scores from the machine learning module and displays the score on the telephone device.

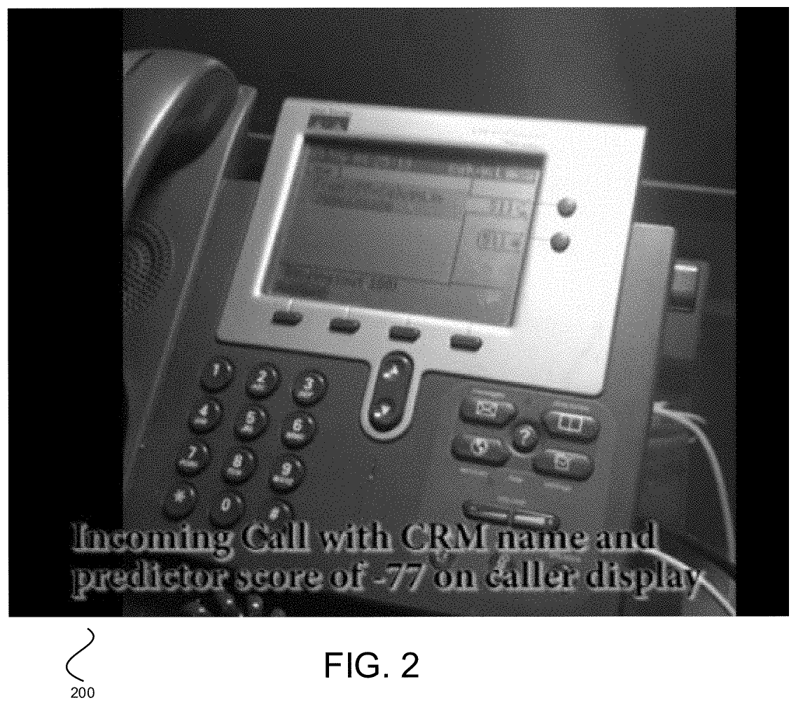

FIG. 2 is an illustrative representation 200 of a telephonic device displaying the end result of the present invention. It may be noted that the representation is merely for the purpose of illustration and does not limit the scope of the devices used and display configurations.

In an embodiment of the present invention, the systems may be connected (e.g., networked) to other machines in a Local Area Network (LAN), an intranet, an extranet, or the public internet. The machine may operate in the capacity of a server or a client machine in a client-server network environment, as a peer machine in a peer-to-peer (or distributed) network environment, as a server or series of servers within an on-demand service environment. Certain embodiments of the machine may be in the form of a personal computer (PC), a tablet PC, a set-top box (STB), a Personal Digital Assistant (PDA), a handheld device, a smart device, a cellular telephone, a smart telephone, a web appliance, a server, a network router, switch or bridge, computing system, or any machine capable of executing a set of instructions (sequential or otherwise) that specify actions to be taken by that machine. Further, while only a single machine is illustrated, the term “machine” shall also be taken to include any collection of machines (e.g., computers or smart devices) that individually or jointly execute a set (or multiple sets) of instructions to perform any one or more of the methodologies discussed herein.

The exemplary computer system includes a processor, a main memory (e.g., read-only memory (ROM), flash memory, dynamic random access memory (DRAM) such as synchronous DRAM (SDRAM) or Rambus DRAM (RDRAM), etc., static memory such as flash memory, static random access memory (SRAM), volatile but high-data rate RAM, etc.), and a secondary memory (e.g., a persistent storage device including hard disk drives and a persistent database and/or a multi-tenant database implementation), which communicate with each other via a bus. Main memory and its sub-elements are operable in conjunction with processing logic and processor to perform the methodologies discussed herein.

Processor represents one or more general-purpose processing devices such as a microprocessor, central processing unit, or the like. More particularly, the processor may be a complex instruction set computing (CISC) microprocessor, reduced instruction set computing (RISC) microprocessor, very long instruction word (VLIW) microprocessor, processor implementing other instruction sets, or processors implementing a combination of instruction sets. Processor may also be one or more special-purpose processing devices such as an application specific integrated circuit (ASIC), a field programmable gate array (FPGA), a digital signal processor (DSP), network processor, or the like. Processor is configured to execute the processing logic for performing the operations and functionality which is discussed herein.

The secondary memory may include a non-transitory machine-readable storage medium or a non-transitory computer readable storage medium or a non-transitory machine-accessible storage medium on which is stored one or more sets of instructions (e.g., software/codes) embodying any one or more of the methodologies or functions described herein. The software may also reside, completely or at least partially, within the main memory and/or within the processor during execution thereof by the computer system, the main memory and the processor also constituting machine-readable storage media. The software may further be transmitted or received over a network via the network interface card.

Some or all of the system components and/or data structures may also be stored as contents (e.g., as executable or other machine-readable software instructions or structured data) on a non-transitory computer-readable medium (e.g., like a hard disk; a computer memory; a computer network or cellular wireless network or other data transmission medium; or a portable media article to be read by an appropriate drive or via an appropriate connection, such as a DVD or flash memory device) so as to enable or configure the computer-readable medium and/or one or more host computing systems or devices to execute or otherwise use or provide the contents to perform at least some of the described techniques. Some or all of the components and/or data structures may be stored on tangible, non-transitory storage mediums. Some or all of the system components and data structures may also be provided as data signals (e.g., by being encoded as part of a carrier wave or included as part of an analog or digital propagated signal) on a variety of computer-readable transmission mediums, which are then transmitted, including across wireless-based and wired/cable-based mediums, and may take a variety of forms (e.g., as part of a single or multiplexed analog signal, or as multiple discrete digital packets or frames). Such computer program products may also take other forms in other embodiments. Accordingly, embodiments of this disclosure may be practiced with other computer system configurations.

It may be noted that the above-described examples of the present solution are for the purpose of illustration only. Although the solution has been described in conjunction with a specific embodiment thereof, numerous modifications may be possible without materially departing from the teachings and advantages of the subject matter described herein. Other substitutions, modifications, and changes may be made without departing from the spirit of the present solution. All the features disclosed in this specification (including any accompanying claims, abstract and drawings), and/or all of the steps of any method or process so disclosed, may be combined in any combination, except combinations where at least some of such features and/or steps are mutually exclusive.

The present description has been shown and described with reference to the foregoing examples. It is understood, however, that other forms, details, and examples can be made without departing from the spirit and scope of the present subject matter.

1. A system and a method for determining certain characteristics of an incoming customer's profile and provide smart recommendations to a business regarding the customer in real time comprising:
a centralized computing system;
telephone devices and computing system with CRM database;
connectivity and accessibility to a phone incoming caller's phone number can be referred as Caller ID,
the Caller ID identifying the actual caller and display on the phone, along with a score generated by machine learning system showing how important the caller is to the company.

2. A method for determining profitability score of an incoming customer call and to show the correct customer name on the phone wherein:
the customers phone number is previously recorded to the company's CRM database;
a call with caller ID displayed once system picks up the caller ID and search the CRM database for matching number;
a true score generated from the machine learning module if data is fetched against the caller id;
the backend system replaces the original caller ID with the relevant score obtained through machine learning and customer's name recorded on CRM earlier and passed on as changed caller ID to the phone display screen.

3. A method for determining profitability score of an incoming customer call and to show the correct customer name on the phone wherein:
the customers phone number is previously not recorded to the company's CRM database;
a method of CRM, where CRM provide interface to phone operator allowing to input information to key in the name of the (new) client, or have additional phone number to a customer's CRM record and
data added in the database and the subsequent call will result in showing the name and score on the phone screen display.
